(19) United States
(12) Patent Application Publication
(10) Pub. No.: US 2020/0383313 A1
(43) Pub. Date: Dec. 10, 2020

(54) METHOD AND DEVICE FOR TREATING GROUNDS AND WEED KILLING DEVICE

(71) Applicant: Zasso GmbH, Aachen (DE)

(72) Inventors: Matthias EBERIUS, Wuerselen (DE); Dirk VANDENHIRTZ, Aachen-Kornelimuenster (DE); Sergio DE ANDRADE COUTINHO FILHO, Indaiatuba (BR)

(73) Assignee: Zasso GmbH, Aachen (DE)

(21) Appl. No.: 16/463,954

(22) PCT Filed: Nov. 28, 2017
(86) PCT No.: PCT/DE2017/000406

§ 371 Date: Jun. 3, 2019

(30) Foreign Application Priority Data
Nov. 28, 2016 (DE) 10 2016 014 101.8

(51) Int. Cl. A01M 21/04; G06Q 10/04; G06Q 50/02

(52) U.S. Cl. CPC A01M 21/046; G06Q 50/02; G06Q 10/04

(57) ABSTRACT

In a method, during weed eradication on ground areas using high voltage and, if necessary, additional technology, data regarding the weed growth are repeatedly captured and, using a computer, a forecast concerning the weed growth is computed, and from this at least one parameter for a subsequent treatment is computed and used to optimize the treatment.

The invention relates to a method and a device for the maintenance of ground areas and to a weed eradication device, in particular a weed control device. As a rule, because it is not possible to completely eradicate an entire population of plants, but only keep it under control, the term “weed control device” is the more accurate description.

Cities and communities in particular have less and less money for removing weeds in urban areas. At the same time, the increasing severity of environmental legislation means that now, practically no herbicides with long-term effects are available, because spraying on hard surfaces (for example traffic areas) is completely forbidden and exemptions are difficult to obtain.

For these reasons too, more and more cities are changing from the zero-tolerance policy towards weeds in public areas, which policy has now all too often become entirely theoretical, to a policy of allowing acceptable levels of weeds through systematic planning. Thus, different guidelines have been specified for different regions in order to determine how much spontaneous vegetation by number and size can be envisaged to be acceptable in a specific region. An intervention is only made when the limits of the guidelines are exceeded. This acceptance of plant growth leads to a number of problems to be solved, however, so that questions regarding safety can be clearly answered, so that maintaining the planned status is economically efficient and so that the number of complaints from citizens can be systematically kept within limits.

The identical questions arise in the field of integrated management of agricultural and non-agricultural areas such as on traffic areas and farmland or for wine and fruit growing, where spontaneous vegetation gradually competes with cultivated plants for water and nutrients and which may constitute a risk of disease or, for example, may cause restrictions to access or give rise to a risk of accidents. In this regard, it has been shown that the challenges of treating traffic areas in urban areas are very similar to those challenges which are encountered when treating areas in vineyards and in orchards. Weeds must be dealt with regularly—but not all weeds have to be removed. The limits set by the guidelines have to be adhered to in an intelligent manner. This leads to the following problems:

All areas which are potentially affected by weed have to be identified efficiently so that they can be managed properly. Each area must be assigned a specific maintenance classification, at best without costly on-site visits. Because logistics planning for maintenance now has to be carried out in a targeted manner rather than the previously employed zero tolerance target, a reorientation from calendar-based (patrol/control every x weeks) to needs-based operations is necessary so that the maintenance targets can be met.

The need for weed management is highly dependent upon weather and local growth conditions. However, these can vary widely both in an urban area or, for example, in a highly-profiled mountainous region because of the large number of influencing factors, and thus are significantly more difficult to predict from larger-scale precipitation or temperature measurements on flat agricultural land.

Based on actual observations, it is almost impossible to set up a sensible requirement plan for the treatment of all urban areas, because for this, they would have to be permanently monitored. The need to forward plan for several days and the naturally limited number of maintenance operatives and maintenance vehicles makes scheduling maintenance plans extremely difficult. Furthermore, dividing urban regions into different maintenance zones leads to an increasing segmentation of the maintenance requirements, which makes it almost impossible to plan routes based simply on habit.

A further serious, if not the most important new biological dynamic, arises due to the different levels of acceptance of more or taller weeds. Because lots of weeds are allowed to grow undisturbed higher/for longer at many locations, and in the case of open ground they are not moved if at all possible, they have a better opportunity to store energy in the rooting bodies. This situation is the same when only the leaves are removed from the surface by mechanical or thermal methods. Regrowth can occur faster because of the energy reserves, and the speed of growth is significantly more dependent on the temperature and the available moisture. Thus, the speed of re-growth is significantly more dependent on the individual plants and their history (when treated, how often and with what methods), which latter is a function of whether and to what extent the plants were able to store energy, and for how long.

The previous scheme from the era of chemical plant protection, in which almost every treated and usually small plant dies following the treatment, and then a completely new growth from seeds begins, is thus being replaced by non-homogeneous management of existing plants. The use of different mechanical and physical removal procedures for different lengths of time makes a prediction even more difficult in the case of root weeds because, for example, electrical removal methods can deeply affect storage roots, while superficial mechanical and thermal methods leave the roots intact.

The use of new types of substructures and joint fillers for hard surfaces and different types of ground can have a considerable influence on regrowth, leaving the logistics manager in charge of weed removal without a reasonable opportunity to identify all of these factors and to apply them appropriately without specific technical solutions.

The quality criteria for an acceptable abundance of weeds have to be converted into a language and regulations that can be evaluated technically/sensorially. It is only in this manner that it can be ensured that the cleaning and measuring vehicles measure usable quantitative information. It is only in this manner that it can be determined that the cleaning has taken place at a time which is within specifications or whether weed control has been carried out too late. This is absolutely necessary for quality assurance of the weed management targets which have been specified.

Because in many cases, thermal and mechanical methods have proved to be only partial solutions to weed management and many regions have in the meantime gone wild due to a lack of maintenance (and so the plants have stored a lot of energy underground), it is vital to find a non-chemical method which has a massive effect on root weeds even in hard surface regions and on traffic areas.

The ensuing aim is achieved by means of a method with the features of patent claim 1. Advantageous further developments are defined in the dependent claims. The solution consists of a series of individual features which achieve the described aim individually and in combination with a plurality of features. With significantly reduced maintenance costs in a differentiated maintenance landscape, this gives rise to a planned maintenance status even under changeable weather conditions and more improved measures for the differentiated management of spontaneous vegetation.

The “ground areas” in this regard are different ground areas in the agricultural and non-agricultural sector which are treated with devices for weed eradication. In this regard, during operations or during treatment, data regarding the weed growth can be captured from various devices and relayed to a computer to be exploited there for self-learning optimization and projection of a forecast.

In particular, these are data regarding the factors influencing weed growth in the region of the ground areas which are captured with the aid of various devices and loaded into a computer and which can be stored in the computer. In this manner, information regarding the quality of the ground and the weeds to be destroyed can be transmitted from the computer to the weed eradication or weed control device in order to select and optimize the operating parameters and methods for weed eradication. The computer can be used to draw up a weed development forecast and to produce a plan for future treatment of the ground area from it.

In particular when, during an operation, data regarding the procedure for weed eradication itself is transmitted to a computer, these data may be used for the quantification and classification of the current ground or weed quality and for a forecast of the local and seasonal ground or weed quality, for the invoicing of tools and treatment costs, for the control of robotic control devices or for system control.

An advantageous device comprises at least one of the following elements:
a GIS-based database with dynamic predictability of weed development,
efficiently installed sensor systems, which provide data during weed control, as far as possible without extra costs,
highly efficient weed management tools for electro-physical control of weeds with pulsed, high-frequency high voltage, which carry the necessary basic sensor equipment and furthermore provides location-specific process data.

The device and the method are suitable for the management and control of areas such as public traffic areas in particular, but also of private traffic areas, parks, cemeteries, infrastructure areas and buildings, overgrown roofs, leisure areas, nature reserves and conservation areas, permanent crop areas such as vineyards and orchards, etc.

Algorithmically speaking, the database may be able to predict the weed growth from newly acquired and historic data and to forecast from it both the actual situation at any time in which the areas have not yet been traversed, and also a usable profile for the next days and weeks. The database can be continuously supplied with real weed data, in particular from the electrophysical weed control units, which leads to a continuous increase in the capability of providing a forecast, even for regions which currently can neither be reached with sensor technology nor can be treated using the electrophysical method (self-learning systems). The operation of the large tools, and also the operation of all other weed management measures, can thus be progressively planned logistically on the basis of this data.

The term “other tools” as used here should be understood to mean any type of tool for cleaning, monitoring and removing weeds, from a portable compact tool via wheeled or people-carrying tools up to entire vehicles with drivers, and also encompassing autonomously moving units independently of the treatment methods used therein and their sensor systems (not necessarily present).

The captured sensor and process data and also the operational data (type, method, etc) for the sensor system which is not connected or only connected to identify the operational area, in combination with known weather conditions (and weather forecasts) and a growth model established from physical/biological or purely empirical data may be used as a part of the method. In this manner, the forecast model can estimate or simulate the actual situation for growth of spontaneous vegetation for individual regions even without further measurement and forecast for the future for a limited period. By comparing the simulation model with the planning maintenance situation and the availability of maintenance operatives and maintenance technology, a dynamic, self-learning working tool for logistic control can then be efficiently generated which supports the relevant fleet manager in respect of decision-making and route planning.

In places where high voltage cannot be used, such as in particular in the vicinity of fences, metal covers, etc, independently of the features of the method discussed above, the exhaust heat from a vehicle engine or from a device for producing high voltage (exhaust gas, cooling water, process heat) may advantageously be used to produce hot water or steam.

The problem to be solved by the invention is solved by using a device which comprises a high voltage means for weakening and eradicating weed, and furthermore comprises a further device for weed control or for weed removal from a traversed region.

The further device may be designed for treatment with chemical agents, or it may be designed as a mechanical device. Advantageously, as the further device, a means is used which uses the exhaust heat such as exhaust gas, cooling water or process heat from a vehicle propulsion unit or a means for producing high voltage for the production of hot water or steam, in order to control weeds thereby.

In order, for example, to be able to use data from street sweepers, walking street cleaning operatives, airborne objects, transport and delivery vehicles and also manually guided compact vehicles or on-board sensor systems such as mobile phones the primary purpose of which is not to eradicate weeds, it is proposed that localized and time-dated data regarding the growth of weeds should be captured from various weed eradication devices or mobile systems and transmitted to the computer. This means that other data are made available with sensor or input devices of this type.

With the aid of empirical and model-based algorithms, a GIS system supplied with measurement data from weed control units and other tools provides an estimate of the actual situation and forecasts the weed development, compares this with predetermined weed management targets and makes appropriate suggestions for optimized control logistics.

As far as is permissible, all of the vehicles used for maintenance are equipped with GPS and, automatically or after manual initialization, input data into the GIS system as to when, where and with which methods the spontaneous vegetation was removed as weeds.

Manual cleaning may also be input as regards the methods, the time and the extent of the area if this has not been carried out automatically by the devices. In particular, partial or fully automatic communication and localization of the equipment via mobile phone applications is part of the method. To this end, cleaning tools carrying weeding equipment are equipped with mobile phone units or interfaces to commercial mobile phone units which are equipped with a data filter in order to comply with operational and data protection requirements so that only legally permissible data can be picked up and transmitted.

The vehicles used for electrophysical weed removal preferably have a sensor system which can specifically draw conclusions about the status of the spontaneous vegetation prior to removal. A continuous determination of the actual values forms the basis for model computations, which incorporate weather and location data (for example shading model, daytime model, temperature model or purely empirical growth factors), being continuously adapted to reality, thereby increasing the reliability of the forecast from the self-learning system.

Advantageously but not exclusively, the vehicles used are treatment vehicles which can carry out an electrophysical treatment of the plants. However, other larger, for example mechanical or thermal treatment units, may be equipped with sensors or process-based information loggers. In addition, tools which are not primarily intended for removing weeds, such as street sweepers or delivery and service vehicles, in particular electrically driven vehicles, may be suitably equipped with sensor systems.

The sensor system may, inter alia but not exclusively, consist of the following sensor systems: green detector, fluorescence measurement, height profile determination, photographic images for the identification of species, image capture for documenting specific situations, active multicolour sensors for the determination of spectral relationships, multi- and hyperspectral cameras, etc.

The vehicles used also transmit information regarding the treatment methods used to the GIS system in a spatially resolved manner so that this may be a further influencing factor for the forecasting algorithm.

The operating system may also be extended from hard ground to green areas and other non-agricultural and agricultural areas with similar management characteristics which have to be managed (cemeteries, meadows, borders, plantations, etc).

In order to simplify data collection, operatives and perhaps also interested citizens may be equipped with mobile phone-based classification systems with GPS tracking which can immediately assess compliance with the stages of maintenance on-site, or can assist with a visual assessment of compliance and document the result.

Local climate models may be optimized by incorporating small weather stations into pedal-powered or preferably electric delivery vehicles, for example for delivering newspapers, parcels and letters. Even busses and police vehicles on street patrol and possibly even street sweepers and other municipal vehicles could contribute to improving the data set by using meteorological data acquisition systems. Here again, the captured data regarding humidity of the air, light intensity, precipitation etc will always be provided to the GIS system in combination with GPS data which is accurate down to the relevant side of the street and will serve to improve the model.

Where it is reasonable and necessary, additional data from existing geodetically based or commercial agricultural and urban models (including, for example Google Maps, Open Streetview and analogous options), flying drones, satellites or sensors based on other aircraft may be used for identifying areas, surface temperatures, shadowing and for comparing weed growth and can be input into the database.

The criteria used in the catalogues of requirements for weed management can be rendered algorithmically ascertainable. To this end, imaging sensor systems are used which consist of a height scan and simultaneous green and preferably fluorescence assessment of the image or, more simply and preferably, a line scan. In the database, the line scans or the narrow strips of the image are associated with a precise region by means of GPS location. These data also constitute the basis for the growth model and are extrapolated onto the overall area to be controlled.

Particular attention should be drawn to tracking invasive and problematic plants which cannot be controlled in a single operation and/or are difficult to see during monitoring. In this case, in addition to forecast data as regards regrowth, monitoring regions may also be defined; every operative who intentionally comes into the vicinity of the area or who passes through it is informed about the need for it to be monitored, either via work assignments or via online notices, In order to identify the sites quickly, they are localized during the current control procedure using GPS. They may also be overlaid onto a real image on a controller's monitor (attached to the vehicle or a mobile facility (possibly a mobile phone)) using augmented reality (“Pokemon function”). In this manner, the areas can be located again during a check or subsequent treatment, their status is recorded (manually/automatically) and further action can be proposed.

The control of invasive plant species, the communication of reports and complaints to and from citizens and operatives can in particular be documented with mobile phone-based apps via the control tools independently of the means. Here again, in accordance with the invention, it is possible to prepare the data in a manner such that the initially identified regions (for example as a result of complaints) can easily be found again using virtual overlays (augmented reality).

The invention will now be illustrated and described with the aid of the drawings. In the drawings:

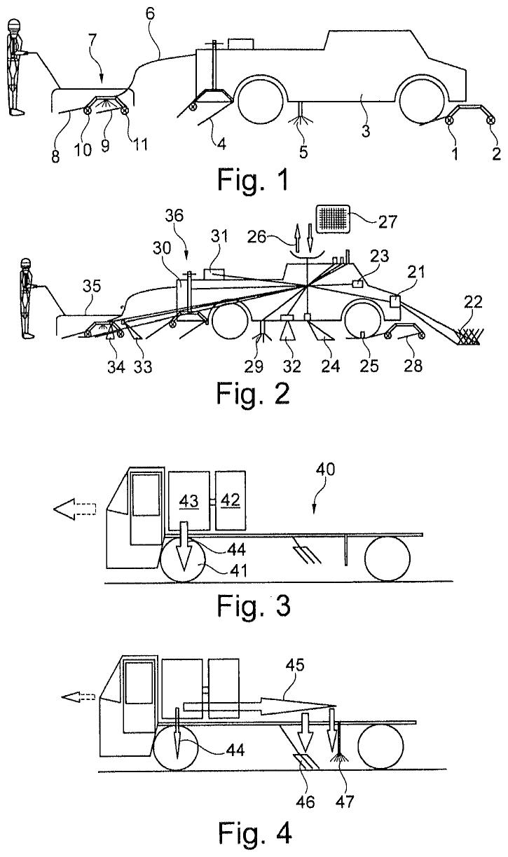

FIG. 1 diagrammatically shows a device for weed eradication with a vehicle,

FIG. 2 diagrammatically shows a device for weed eradication with a sensor system and GPS,

FIG. 3 shows a vehicle with a hybrid design during operation,

FIG. 4 shows a vehicle with a hybrid design during a weed eradication operation, and

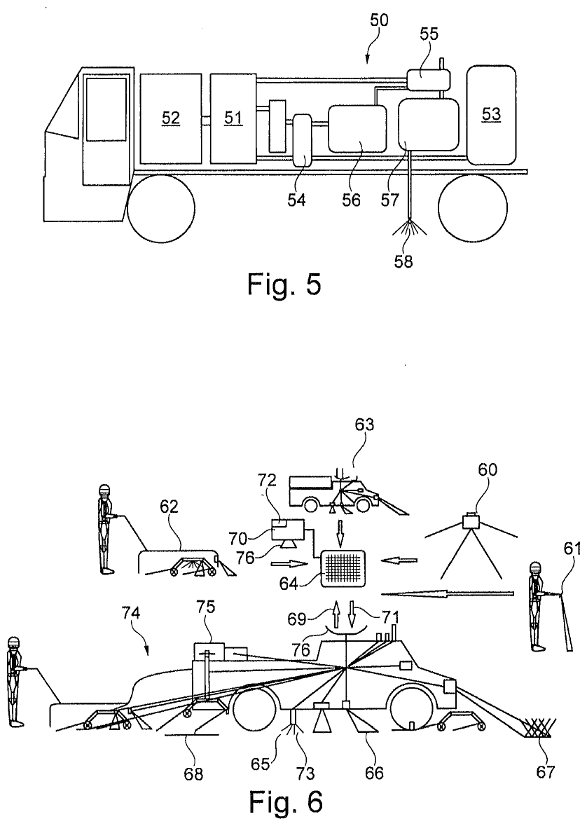

FIG. 5 shows the use of data from different sources.

FIG. 1 shows how weed eradication can be carried out on a vehicle 3 with fixed trailing applicators 1, 2 which may also be configured as brushes. Robotically moved trailing or brush applicators 4 as applicators of a high voltage production means (not shown) are disposed at the back in the exemplary embodiment. In addition, hot water jets 5 are disposed on the vehicle 3 so that the vehicle 3 can be used as a hybrid system. A detachable compact system 7 is connected to the vehicle 3 via a cable 6. The compact system 7 may also be autonomously, robotically or manually operated. It has trailing contacts 8, 9 and floats on an air cushion, or is trailed, or it rolls on wheels 10, 11. The compact system 7 may also be equipped with a battery so that it can be used independently of the vehicle. The support vehicle 1 shown here may, for example, be a tractor, a heavy goods vehicle, a pickup, a light truck, a quad bike, an autonomous vehicle or a manually operated unit.

FIG. 2 shows how a sensor system 21 can be used to identify the height and spread of plants 22 can be detected and localized by means of a GPS system 23. At the same time, data regarding the quality of the subsoil, i.e. the ground area 24, the ground clearances and the tyre guidance 25, can be captured. The sensor system delivers current data, which can be compared with historic data which is obtained via a transmitter and receiver unit 26. The transmitter and receiver unit 26 is wirelessly connected to the database 27 in order to be able to store current data in the database 27 and in order to be able to call up historical data. In this manner, applicators 28, spray jets 29, robotic units 30 and, if appropriate, the energy supply 31 as well and, for example, the steering as well, can be controlled in an optimized manner. A further sensor serves to identify the route conditions 32. The plant data in the database 27 serve for comparison and to provide a forecast of the growth model. The sensor system 33, 34 may also be located on manually operated compact tools 35 and support vehicle-based (fixed or robotically connected) compact tools (not shown). The vehicle 36 may also be provided with a sensor system alone and without weed control.

In the vehicle 40 shown in FIG. 3, the wheels 41 are optionally electrically driven. The energy 44 for this is supplied as current through a motor/generator combination 42, 43 or a fuel cell (not shown). When operated slowly, a large proportion of the energy 45 goes into weed control with the trailing contacts 46 and the hot water jet 47. When in drive mode, the energy 44 primarily goes into the propulsion units.

FIG. 5 diagrammatically shows how, in a vehicle 50, the exhaust heat from the vehicle propulsion unit 51 (onboard engine, electrically or hydraulically coupled internal combustion engine or, if appropriate, also a fuel cell to replace the engine and generator) which generally also supplies the generator 52, can heat the onboard water 53 in one or two stages with a heat exchanger 54 for cooling water and a heat exchanger 55 for exhaust gas, and the hot water from the tanks 56 and 57 in particular can be used where electrical control is not possible; jets 58 are used in order to control weeds or unwanted organisms or also to just clean a surface. The jets 58 are used in particular on metallic manhole covers and gutter gratings, or at locations which are difficult to access such as fences and steel masts. It is deployed with a spraying unit with jets 58 attached to the vehicle 50 or with a hand-held lance or other robotic means (not shown).

FIG. 6 diagrammatically shows how data which is currently being recorded using the sensor system 66, 67 and data from previous weed treatments 62, 63 which have been stored in the database 64 of the computer 70 and which are transmitted via the interface to the system, is used for controlling and parameterizing the system. In this manner, the various applicator systems 1, 2, 4, 8, 9 shown in FIG. 1 can parameterize an alternative weed control system 5, 73 and thus enable efficient and specific deployment.

FIG. 6 shows in detail how data from various sources, such as from drones 60, mobile phone sensors 61, mobile processing means 62, delivery vehicles (not shown), satellites (not shown), other street cleaning vehicles 63, etc as well as data regarding weeds, weather and microclimate, can be input into a database 64 so that routes for the weed control vehicles 65 can be planned or local weed control vehicles can be controlled. For this purpose, a growth forecast can be calculated based on the data collected in the database 64. The figure also shows how the availability of data regarding the terrain 66 and data regarding weeds 67 from previous trips and other sources can be entered into the database to allow autonomously operating robotic systems to operate much faster and more effectively by including the database-based model of the terrain and the weed forecast than was possible when the sensors of the weed control vehicle 65 initially scanned all areas and then started operations.

FIG. 6 thus shows a method for the maintenance of ground areas 68, in which data 69 regarding weed growth is repeatedly acquired over intervals of time, a forecast regarding weed growth is computed therefrom using a computer 70 and from this, at least one parameter 71 for a future treatment is computed. In this regard, it is possible for the data 69 to be captured during maintenance. Advantageously, the computation of the parameter 71 for the future treatment uses a self-learning optimization method. To this end, the computer 70 should comprise a geoinformation system 72 with a time reference.

In this manner, localized and time-dated data 69 regarding the weed growth can be captured from different weed eradication devices 62, 63 and 74 or mobile systems 60, 61 and transmitted to the computer 70.

The availability of the maintenance operatives and weed eradication devices as well as weather data and light information regarding the region of the ground areas to be maintained can also be input into the computer 70 and can then be used for planning the operations.

Advantageously, values regarding the status of the weeds prior to their treatment with a weed eradication device are contained in the data 69 regarding the weed growth and these are subsequently displayed on-site via electronic systems such as screens, overlays, VR glasses (not shown).

The weed eradication device 62, 63, 74 may be moved manually or with a vehicle 3. It can transmit data wirelessly or by cable to a mobile system 61 such as, in particular, a mobile phone, which then relays the data to the computer 70.

The ground area 68 may be treated with different weed eradication devices 62, 63, 74 and the at least one parameter 71, which may also be a forecast, can be overlaid in a spatially localized manner on the screen of a mobile camera system such as, for example, a mobile phone.

In order to produce hot water or steam 73, as can be seen in FIG. 5, the exhaust heat from a vehicle propulsion unit 51 may be used or the exhaust heat from a means for producing high voltage (exhaust gas, cooling water, process heat) may be used in order to use hot water or steam for working on the ground.

The weed eradication device 74 comprises a sensor system 21, 33, 34 for detecting the weed growth and an interface 76 so that it can transmit data 69 to a computer 70 wirelessly or via a cable. The computer 70 comprises an interface 76 so that it can transmit data 69 or computed data to a mobile system 61, such as a mobile phone in particular. For the purposes of weed eradication, it has a high voltage means 75 for weakening and eradicating the weed and furthermore, it has at least one further device such as the jets 47 for producing steam 73 for weed control or for weed removal from the region being traversed.

1. A method for the maintenance of ground areas (24) with a weed eradication device (62, 63, 74), in which at different points in time, data (69) concerning the weed growth is captured, a computer (70) is used to compute a forecast regarding the weed growth therefrom and at least one parameter (71) for a future treatment is computed therefrom.

2. The method as claimed in claim 1, wherein the data (69) are captured during the maintenance.

3. The method as claimed in claim 1, wherein data from other sources, such as from other vehicles or other systems carrying sensors in particular, are incorporated independently of the maintenance.

4. The method as claimed in claim 1, wherein a self-learning optimization method is used for the computation of the parameter (71) for the future treatment.

5. The method as claimed in claim 1, wherein the computer (70) comprises a geoinformation system (72) with a time reference.

6. The method as claimed in claim 1, wherein localized and time-dated data are captured from different weed eradication devices (62, 63, 74) or mobile systems (60, 61) and transmitted to the computer (70).

7. The method as claimed in claim 1, wherein the exhaust heat from a vehicle propulsion unit (51) or from a means for producing high voltage is used for the production of hot water or steam (73).

8. The method as claimed in claim 1, wherein the availability of maintenance operatives and weed eradication devices (62, 63, 74) are also input into the computer (70) and can then be used for planning the operations.

9. The method as claimed in claim 1, wherein weather data and light information concerning the region of the ground area (68) to be maintained are input into the computer (70).

10. The method as claimed in claim 1, wherein the data (69) regarding weed growth contains values regarding the status of the weeds prior to their treatment with a weed eradication device (62, 63, 74) and this is subsequently displayed on-site via electronic systems such as screens, overlays, VR glasses, etc.

11. The method as claimed in claim 1, wherein the weed eradication device (62, 63, 74) is moved manually or with a vehicle (3).

12. The method as claimed in claim 1, wherein the weed eradication device (62, 63, 74) transmits data wirelessly or via a cable to a mobile system (61) which transmits the data to the computer (70).

13. The method as claimed in claim 1, wherein the ground area (68) is treated with different weed eradication devices (62, 63, 74) and the at least one parameter (71), which may also be a forecast, is overlaid in a spatially localized manner on the display of a mobile camera system such as a mobile phone, for example.

14. A weed eradication device (62, 63, 74), in particular for use in a the method as claimed in claim 1, wherein it comprises a sensor system (21, 33, 34) for identifying the weed growth and an interface (76) for the wireless or cabled transmission of data (69) to a computer (70).

15. The weed eradication device as claimed in claim 14, wherein the computer (70) comprises an interface for transmitting the data (69) or computed data to a mobile system (61) such as a mobile phone in particular.

16. The weed eradication device in particular as claimed in claim 14, wherein for the purposes of weed eradication, it comprises a high voltage means (75) for weakening and eradicating weeds and furthermore, it comprises at least one further device (73) for weed control or for weed removal from a traversed region.
